(19) United States
(12) Patent Application Publication
(10) Pub. No.: US 2006/0265298 A1
(43) Pub. Date: Nov. 23, 2006

(54) Method and system of searching for lost property by using credit card

(75) Inventors: Ronald Lee, Sindian City (TW); Gino Li, Sindian City (TW)

Correspondence Address: BACON & THOMAS, PLLC, 625 SLATERS LANE, FOURTH FLOOR, ALEXANDRIA, VA, 22314, US

(73) Assignees: Ronald Lee, Sindian City (TW); Gino LI, Sindian City (TW)

(21) Appl. No.: 11/311,316

(22) Filed: Dec. 20, 2005

(30) Foreign Application Priority Data
May 19, 2005 (TW) 094116322

(51) Int. Cl. G06Q 40/00; G06F 7/00; G06F 17/00

(52) U.S. Cl. 705/35; 707/100

(57) ABSTRACT

The invention discloses a method and system of searching for lost property by using credit card used in a credit card service system for searching for a lost suitcase, passport, old person or child with an attached card. The attached card is recorded with at least part of a credit card number. When a lost property is found, an attached card reading device is used to read the partial credit card number, and transmit it and the ID of the reading device to the control center for being stored in the database. Once the user finds his/her property is lost, he/she could transmit a searching message via any credit card reader, thereby the control center compares the searching credit card number and its database so as to find the corresponding contact data matching the searching message, and transmits the contact data to the user for getting his/her lost property back.

### BACKGROUND OF THE INVENTION

1. Field of the Invention

The present invention relates to a method and system of searching for lost property, and more particularly, to a method and system of searching for lost property by using a credit card.

2. Description of Related Art

If people lose their luggage when they go out or travel around, it might always take them great effort to get their luggage back. Generally, there's a tag recorded with the contact information of the owner tied to the luggage, such that those who pick up the luggage can inform the owner according to the tag information. However, if the person who picks up the luggage doesn't follow the tag information to inform the luggage owner, if the contact information has been changed, or if the tag is broken, it'd be much more difficult for the owner to get the luggage back. Further, as for the elderly with dementia or the children, it'd be hard to find most of them back once they get lost. Even though they're eventually found, it has already taken a lot of searching time. These lost people have the same problem of the lost luggage, that is, most of them don't have contact information such that other people might fail to help them to find their family.

Currently, almost everyone owns a credit card. Especially for those who go out or travel around, it is necessary for them to carry a credit card in hand. Therefore, it is desirable to enhance the function of the credit card so as to provide a method and system of searching for lost property by using credit card to mitigate and/or obviate the aforementioned problems.

### SUMMARY OF THE INVENTION

The present invention relates to a method and system of searching for lost property by using a credit card used in a credit card service center for searching for a lost property. The above lost property includes an attached card, and the attached card is recorded with identification data, which includes at least a part of a credit card number. The aforementioned system comprises: at least one attached card reading device, a control center, at least one credit card reader, and a credit card network. The at least one attached card reading device is set in at least one designated location used for reading the attached card of the lost property, so as to retrieve the identification data and its corresponding part of the credit card number, and to construct a lost message by integrating the identification data and the contact information of the designated location. The control center comprises a database, and the control center is used for receiving the lost message, and storing the contact information, identification data and its corresponding part of the credit card number of the lost message into the database. The at least one credit card reader is used for reading a searching credit card number, and transmitting a searching message including the searching credit card number to the control center. The credit card network is connected to the control center, the at least one attached card reading device and the at least one credit card reader. When receiving the searching message, the control center searches the database to find out the part of the credit card number matching the searching credit card number, and transmits the contact information of the designated location corresponding to the matching part of the credit card number to the at least one credit card reader.

According to another aspect of the present invention, the method of searching for lost property by using credit card comprises the steps of: (A) the control center receiving a lost message transmitted from the at least one attached card reading device, and storing the lost message into the database, the lost message including the contact information of the designated location of the attached card reading device, and the corresponding part of the credit card number; (B) the control center receiving a searching message transmitted from the at least one credit card reader, the searching message including a searching credit card number; (C) the control center searching the database so as to find out the part of the credit card number matching the searching credit card number; and (D) the control center transmitting the contact information of the designated location corresponding to the matching part of the credit card number to the at least one credit card reader. Consequently, if the lost property has been found and its relevant information has been recorded in the database of the control center, the owner of the lost property can obtain the contact information of the designated location of the lost property by transmitting a searching message from any of the credit card readers, so as to get the lost property back.

Further, the lost property could be a lost suitcase, personal goods, a passport, a wallet, or lost people and childe, etc. While the aforementioned attached card could be a magnetic card, an IC card, a magnetic code, a chip or the like, so as to store partial or full credit card numbers.

The above identification data further comprises relevant data of the owner of the lost property, such as name, contact telephone number, address, and other personal information for the purpose of identification confirmation.

The above designated location could be a hotel, an airport service center, a restaurant, a police office, or other lost-and-found centers.

The above contact information of the designated location could be a contact telephone number, an email account, an address, and so on.

Other objects, advantages, and novel features of the invention will become more apparent from the following detailed description when taken in conjunction with the accompanying drawings.

### BRIEF DESCRIPTION OF THE DRAWINGS

FIG. 1 illustrates a system structure of one preferred embodiment according to the present invention;

FIG. 2 depicts an exemplary attached card of the preferred embodiment according to the present invention;

FIG. 3 illustrates a flowchart of the preferred embodiment according to the present invention; and

FIG. 4 depicts a schematic drawing of data storage of the preferred embodiment according to the present invention.

### DETAILED DESCRIPTION OF THE PREFERRED EMBODIMENT

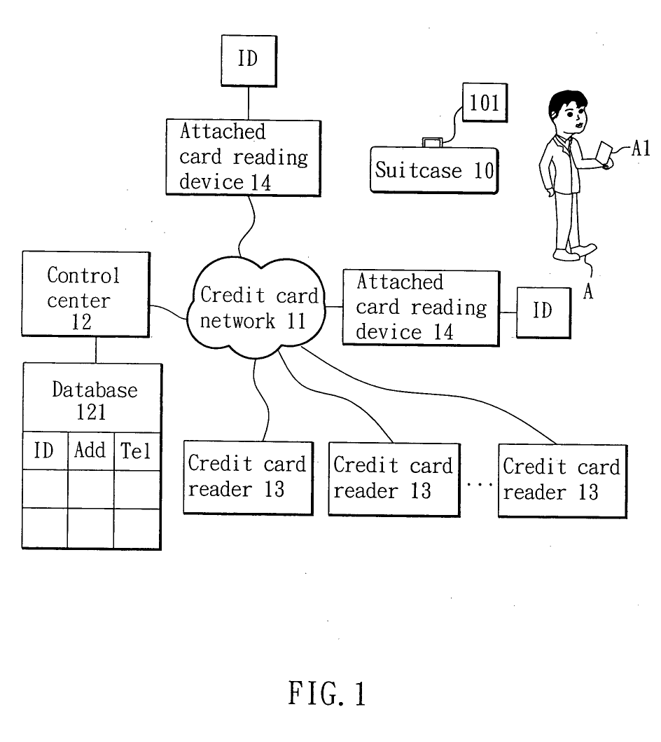

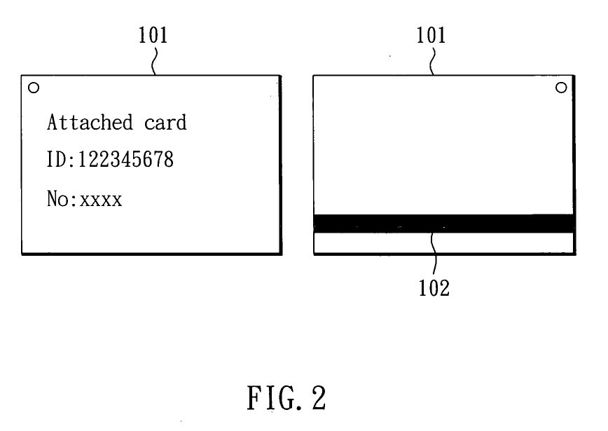

Please refer to FIG. 1, which illustrates a system structure of one preferred embodiment according to the present invention. As shown in FIG. 1, User A lost his/her suitcase 10 during his/her trip, where an attached card 101 is attached to the lost suitcase 10. The attached card 101 is recorded with the identification data of User A, including his/her name and the full or partial credit card number of his credit card Al, for example, first four codes or last four codes as a protection of the credit card A1 from being fraudulently used. With reference to FIG. 2, FIG. 2 depicts an exemplary attached card 101 of the preferred embodiment according to the present invention. The size of the attached card 101 is equal to that of a normal credit card. The front of the attached card 101 is recorded with the identification data of User A; while the back of the attached card 101 has a magnetic stripe 102 also recorded with the identification data of User A. This attached card 101 can be issued by the credit card company together with the credit card. Further, the attached card 101 can also be in the form of an IC card. That is, there is an IC (not shown) recorded with the identification data of User A embedded in the attached card 101.

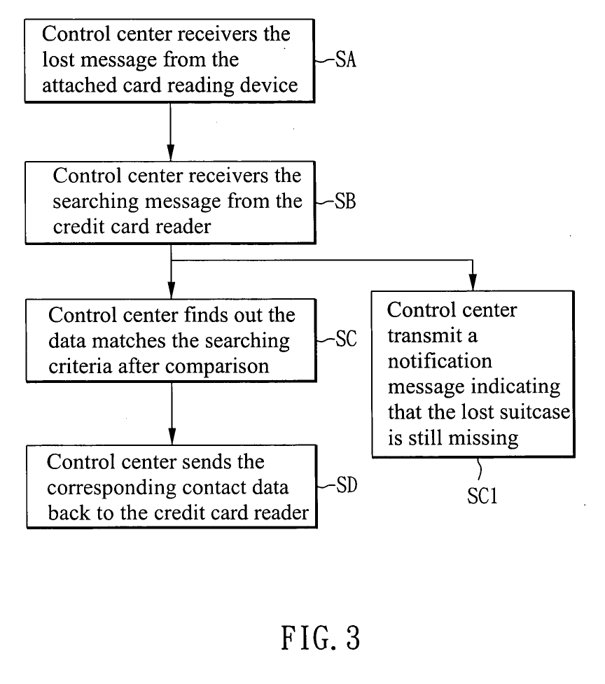

The system as shown in FIG. 1 includes a control center 12, credit card readers 13 and attached card reading devices 14 each connected to one another via a credit card network 11. Like the credit card reader 13, each attached card reading device 14 has an identification code (ID) for providing the location and relevant information of the attached card reading device 14. The aforesaid attached card reading device 14 can be set in hotels, airport service centers, restaurants, police offices, and other lost-and-found centers for taking care of lost properties, such as lost suitcases 10. The control center 12 comprises a database 121 for storing data, wherein the database 121 is pre-stored with IDs and corresponding information of attached card reading devices 14, such as the title, address and telephone number of the location. Please also refer to FIG. 3, which illustrates a flowchart of the preferred embodiment according to the present invention. If someone picks up the lost suitcase 10 and sends it to the hotel, the attached card 101 of the lost suitcase 10 could be read or sensed by the attached card reading device 14 so as to retrieve the part of the credit card number and name. Therefore, the attached card reading device 14 constructs a lost message by integrating the part of the credit card number, the name, and the ID of the attached card reading device 14 of the hotel, and then sends the lost message to the control center 12. Next, the control center 12 stores the part of the credit card number, the name, and the ID of the attached card reading device 14 into the database (Step SA).

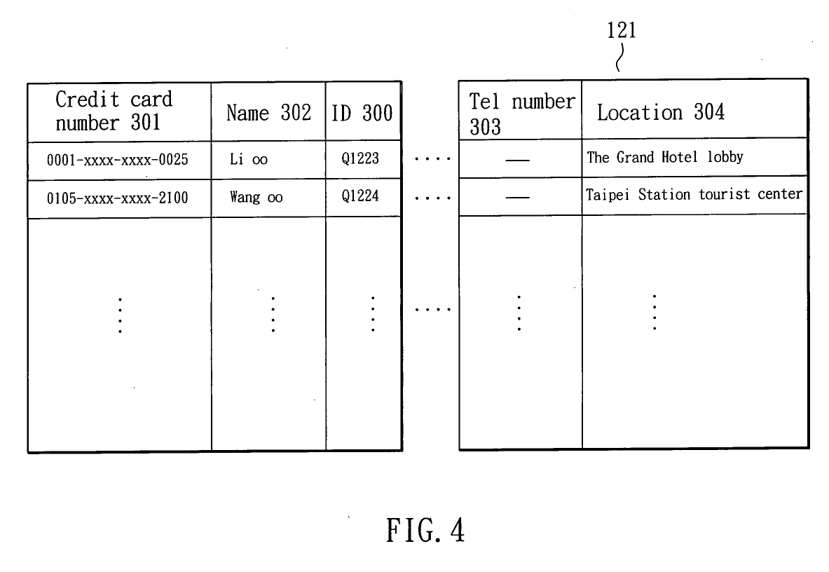

With reference to FIG. 4, it depicts a schematic drawing of data storage of the preferred embodiment according to the present invention. As shown in FIG. 4, the database 121 is stored with the part of the credit card number 301, the name 302, and the ID 300 of its corresponding attached card reading device 14 recorded in the attached card 101 of the lost suitcase 10, wherein the ID 300 relates to the location 304 and telephone number 303 of the attached card reading device 14. When User A wishes to search for his lost suitcase 10, he/she only needs to operate the credit card reader 13 to search for the lost property at anyplace having the credit card reader 13, such as general stores, restaurants, and etc. For example, the operator could press a specific control key, like ‘*’ or ‘#’, as an indication of processing the lost property searching procedure rather than the normal payment procedure. Then, the operator could use the credit card reader 13 to transmit a searching message having the credit card number, such as 0001-2225-3366-0005, and/or the user name to the control center 12 (Step SB). After the control center 12 receives the searching message, it starts to search the database 121 so as to find out the part of the credit card number and/or the user name matching the searching credit card number. Please refer to FIG. 3, if the control center 12 finds out the first data matches the searching criteria after comparison (Step SC), it sends the corresponding contact data (including location 304 and telephone number 303) back to the credit card reader 13 (Step SD), thereby the contact data could be displayed on the screen of the credit card reader 13, or the credit card reader 13 could print out the contact data and provide to User A, such that User A could call the hotel or directly go to the hotel to get his lost suitcase 10 back. However, if the control center 12 couldn't find out any part of the credit card numbers match the searching credit card number, it would transmit a notification message indicating that the lost suitcase 10 is still missing (Step SC1).

According to the above description, the present invention utilizes the credit card that almost everyone has at least one in hand to search for the lost property. As a result, if the user lost some property, the only thing he/she needs to do is to find one store and use his/her credit card, such that he/she could easily get to know the location of the lost property via the message transmission mechanism of the credit card network, so as to get the lost property back soon.

The lost property is not limited to the abovementioned things, it could also be a passport, a wallet, a laptop, other personal goods, children or the elderly with dementia. Similarly, the attached card 101 can also be attached to children or old people, wherein the attached card 101 can be designed as a necklace-like IC card for easy wearing. Consequently, it can be easy and quick to find the lost children or the elderly with dementia back just as the lost suitcases.

Although the present invention has been explained in relation to its preferred embodiment, it is to be understood that many other possible modifications and variations can be made without departing from the scope of the invention as hereinafter claimed.

What is claimed is:

1. A method of searching for lost property by using a credit card used in a credit card service center for searching for a lost property, the lost property including an attached card, the attached card recorded with identification data, the identification data including at least a part of a credit card number, the credit card service center comprising a control center, at least one attached card reading device and at least one credit card reader each connected to one another via a credit card network, the at least one attached card reading device defined with a corresponding identification code, the control center comprising a database pre-stored with identification codes and their corresponding attached card reading device information, the method comprising the steps of:
(A) the control center receiving a lost message transmitted from the at least one attached card reading device, and storing lost message into the database, the lost message including the identification code of the attached card reading device, and the corresponding part of the credit card number;
(B) the control center receiving a searching message transmitted from the at least one credit card reader, the searching message including a searching credit card number;
(C) the control center searching the database so as to find out the part of the credit card number matching the searching credit card number; and
(D) the control center finding out the corresponding attached card reading device information according to the corresponding identification code of the matching part of the credit card number, and transmitting the attached card reading device information to the at least one credit card reader.

2. The method of searching for lost property by using credit card as claimed in claim 1, wherein step (C) further comprises the following step:
(C1) transmitting a notification message to the at least one credit card reader if none of the part of the credit card numbers match the searching credit card number after searching the database, the notification message indicating that no one has found the lost property.

3. The method of searching for lost property by using credit card as claimed in claim 1, wherein the identification data further includes relevant data of an owner of the lost property.

4. The method of searching for lost property by using credit card as claimed in claim 1, wherein the attached card reading device information includes a location and a contact telephone number of the attached card reading device.

5. The method of searching for lost property by using credit card as claimed in claim 4, wherein the location is a hotel.

6. The method of searching for lost property by using credit card as claimed in claim 1, wherein the lost property is a lost suitcase.

7. A system of searching for lost property by using credit card used for searching for a lost property, the lost property including an attached card, the attached card recorded with identification data including at least a part of a credit card number, the system comprising:
at least one attached card reading device defined with a corresponding identification code, the at least one attached card reading device being set in a designated location for reading the attached card of the lost property, so as to retrieve the identification data which includes the part of the credit card number, and to construct a lost message by integrating the identification data and the identification code;
a control center comprising a database pre-stored with identification codes and their corresponding attached card reading device information, the control center receiving the lost message, and storing the identification code and the identification data of the lost message into the database;
at least one credit card reader for reading a searching credit card number, and transmitting a searching message including the searching credit card number to the control center; and
a credit card network being connected to the control center, the at least one attached card reading device, and the at least one credit card reader;
wherein when receiving the searching message, the control center searches the database to find out the part of the credit card number matching the searching credit card number, finds out the corresponding attached card reading device information according to the corresponding identification code of the matching part of the credit card umber, and transmits the attached card reading device information to the at least one credit card reader.

8. The system of searching for lost property by using credit card as claimed in claim 7, wherein the identification data further includes relevant data of an owner of the lost property.

9. The system of searching for lost property by using credit card as claimed in claim 7, wherein the control center transmits a notification message to the at least one credit card reader if none of the part of the credit card numbers match the searching credit card number, the notification message indicates that no one has found the lost property.

10. The system of searching for lost property by using credit card as claimed in claim 7, wherein the attached card reading device information includes a location and a contact telephone number of the attached card reading device.

11. The system of searching for lost property by using credit card as claimed in claim 10, wherein the location is a hotel.

12. The system of searching for lost property by using credit card as claimed in claim 7, wherein the lost property is a lost suitcase.
